(19) United States
(12) Patent Application Publication
(10) Pub. No.: US 2014/0325836 A1
(43) Pub. Date: Nov. 6, 2014

(54) METHOD AND SYSTEM FOR HIGH DENSITY PRESS-FIT CONNECTOR REMOVAL

(71) Applicant: FUJITSU NETWORK COMMUNICATIONS, INC., Richardson, TX (US)

(72) Inventor: Jimmy Kevin Cloer, Garland, TX (US)

(73) Assignee: Fujitsu Network Communications, Inc., Richardson, TX (US)

(21) Appl. No.: 13/886,885

(22) Filed: May 3, 2013

(51) Int. Cl. H01R 43/20; H01R 43/26

(52) U.S. Cl. CPC H01R 43/205; H01R 43/26
USPC 29/829; 29/762

(57) ABSTRACT

A system for removing connector pins from a circuit board includes two clamp plates. The system further includes a plurality of pin plates coupled between the clamp plates. The plurality of pin plates are configured to be positioned between adjacent rows of the connector pins. The system also includes an attachment block coupled between the clamp plates. The attachment block is configured with an inset that corresponds with a notch on each of the plurality of pin plates for linking vertical movement of the plurality of pin plates and the attachment block. The system includes a tightening mechanism to tighten the clamp plates and the plurality of pin plates around the connector pins.

### TECHNICAL FIELD

The present invention generally relates to repair equipment for electronics, and more particularly to removal of high density press-fit connectors from circuit boards.

### BACKGROUND

During normal assembly processing of circuit boards using connectors for telecommunications and other electronic equipment, occasional repairs must be made. Sometimes the repair requires removal of the press-fit Z-pack or similar connectors. Press-fit connectors have a plurality of contact elements pressed into contact holes in a printed circuit board, and usually employ a plastic housing. Connector pins are usually closely spaced in rows arranged in a matrix. In the past, each connector pin has been removed manually, one at a time. This process is generally slow and labor intensive, and may also lead to stress injuries for workers who have to remove a large number of connector pins.

Available off-the-shelf tooling is inadequate to remove large numbers of connector pins safely and effectively. Simple hand tools, like pliers, may also be used to remove connector pins, but these are also inadequate for many situations.

High density press-fit connectors are well-known and widely used in the electronics manufacturing industry. Press-fit connectors have a plurality of contact elements (pins) pressed into contact holes in a printed circuit board. The pins create connections between the printed circuit board and whatever components are plugged into the top side of the press-fit connector. Press-fit contacts rely on a tight-fitting mechanical mating engagement with plated holes on a circuit board in order to establish electrical contact. During normal assembly processing, repairs must sometimes be made to the circuit board or to the press-fit connector. This may require the removal of the press-fit connector, which may be difficult to do without damaging the circuit board.

### SUMMARY

In particular embodiments, a system for removing connector pins from a circuit board includes two clamp plates. The system further includes a plurality of pin plates coupled between the clamp plates. The plurality of pin plates are configured to be positioned between adjacent rows of the connector pins. The system also includes an attachment block coupled between the clamp plates. The attachment block is configured with an inset that corresponds with a notch on each of the plurality of pin plates for linking vertical movement of the plurality of pin plates and the attachment block. The system includes a tightening mechanism to tighten the clamp plates and the plurality of pin plates around the connector pins.

In another embodiment, a system for removing connector pins from a circuit board includes two clamp plates and a plurality of pin plates coupled between the clamp plates. The plurality of pin plates are configured to be positioned between adjacent rows of the connector pins. The system further includes an attachment block coupled between the clamp plates. The attachment block is configured with a notch that corresponds with an inset on each of the plurality of pin plates for linking vertical movement of the plurality of pin plates and the attachment block. The system also includes a tightening mechanism to tighten the clamp plates and the plurality of pin plates around the connector pins.

In another embodiment, a method for removing connector pins from a circuit board includes placing a removal tool on the connector pins. The removal tool includes two clamp plates and a plurality of pin plates coupled between the clamp plates. The plurality of pin plates are configured to be positioned between adjacent rows of the connector pins. The removal tool further includes an attachment block coupled between the clamp plates. The attachment block is configured with an inset that corresponds with a notch on each of the plurality of pin plates for linking vertical movement of the plurality of pin plates and the attachment block. The removal tool also includes a tightening mechanism to tighten the clamp plates and the plurality of pin plates around the connector pins. The method includes tightening the removal tool and placing a frame assembly over the removal too. The method further includes coupling the frame assembly and the removal tool.

The object and advantages of the invention will be realized and attained by means of at least the features, elements, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 illustrates an example connector removal tool, in accordance with one embodiment of the present disclosure;

FIG. 2 illustrates an exploded view of the example connector removal tool shown in FIG. 1, in accordance with one embodiment of the present disclosure;

FIG. 3 illustrates an example frame assembly that may be used in association with the connector removal tool shown in FIG. 1, in accordance with one embodiment of the present disclosure;

FIG. 4 illustrates another example connector removal tool, in accordance with one embodiment of the present disclosure;

FIG. 5 illustrates an exploded view of the example connector removal tool shown in FIG. 4, in accordance with one embodiment of the present disclosure;

FIG. 6 illustrates an example frame assembly that may be used in association with the example connector removal tool shown in FIG. 4, in accordance with one embodiment of the present disclosure; and

FIG. 7 illustrates an example method for removal of connectors, in accordance with one embodiment of the present disclosure.

### DETAILED DESCRIPTION

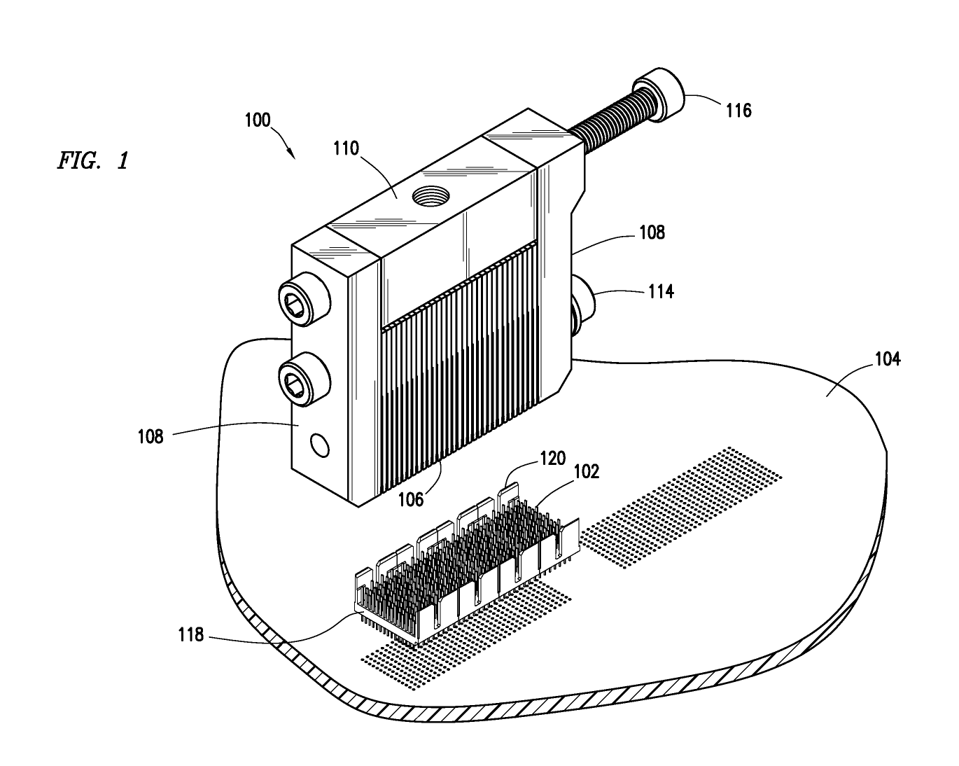

Embodiments of the present invention and its advantages are best understood by referring to FIGS. 1-7 of the drawings, like numerals being used for like and corresponding parts of the various drawings.

FIG. 1 illustrates an example connector removal tool 100, in accordance with one embodiment of the present disclosure. Connector 118 may include connector pins 102 that may be protruding from backplane 104. Removal of connector 118 and/or connector pins 102 may be accomplished by the use of removal tool 100. Although removal tool 100 is shown in association with backplane 104, removal tool 100 may also be used with any other suitable type of circuit board that uses connector pins. In operation, removal tool 100 may sit on backplane 104. Removal tool 100 may utilize a plurality of pin plates 106 that may be pressed together to grasp connector pins 102 and/or connector 118 for removal. Clamp plates 108 may be placed around the pin plates 106. Clamp plates 108 may be used to help tighten pin plates 106 around connector pins 102. An attachment part, such as attachment block 110, may facilitate removal of removal tool 100, connector pins 102, and/or connector 118 from backplane 104. Functionally, removal tool 100 may provide an arrangement that may allow pin plates 106 to be pressed together so that they clamp connector pins 102. Alignment screw 114 may operate to loosely hold pin plates 106 in position between clamp plates 108. Tightening bolt 116 may be used to clamp pin plates 106 and clamp plates 108 onto connector pins 102 for removal. Use of removal tool 100 may reduce the time and expense to remove connector 118 compared to use of individual connector pin removal methods, e.g. using pliers to remove connector pins individually. Further, removal tool 100 may reduce repetitive stress injuries for users that remove a significant amount of connectors 118.

In some embodiments, connector 118 may be a high density press-fit backplane connector and may include a plurality of connector pins 108. Connector 118 and connector pins 108 may be electronically connected to backplane 104. Further, connector 118 may include tabs 120 that may be removable. For example, tabs 120 may be manufactured from a hard plastic such that, during removal, tabs 120 may be snapped off of connector 118. Connector 118 may be installed on backplane 104 using press fit, interference fit, and/or any other suitable installation method. Connector 118 may be of any suitable size and multiple connectors 118 may be stacked end-to-end based on the requirements of a particular implementation. Connector pins 102 may have a cross-section that may be circular, square, rectangular, and/or any other suitable cross-section. For example, connector pins 102 may be rectangular in cross-section such that two opposite sides of each connector pin may be wider that the other two opposite sides.

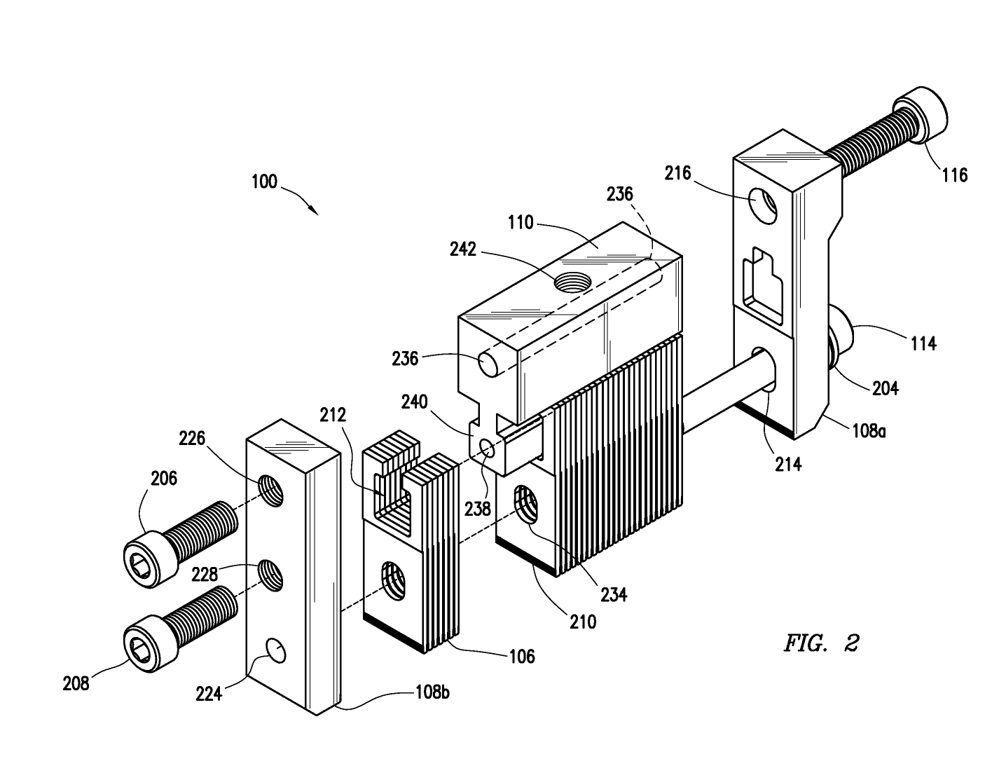

FIG. 2 illustrates an exploded view of example connector removal tool 100 shown in FIG. 1, in accordance with one embodiment of the present disclosure. In this view, the individual pieces of removal tool 100 may be seen. Removal tool 100 may include pin plates 106, clamp plates 108, attachment block 110, tightening bolt 116, alignment screw 114, alignment bearing 204, fixed tightening bolt 206, fixed alignment screw 208, and/or any other suitable components based on implementation. Connector tool 100 may be illustrated configured with particular dimensions, e.g., a particular height based on the height of the connector and/or connector pins to be removed, a particular width based on the width of the connector and/or connector pins to be removed, and a particular thickness based in part on the number of rows of pins on the connector to be removed. However, connector tool 100 may be of any dimensions suitable for a particular implementation or based on the dimensions of the connector to be removed.

Pin plates 106 may include a plurality of plates configured to grasp connector pins 102. Pin plates 106 may be manufactured from a hard material, such as metal, or any other suitable material that may withstand the clamping force applied by clamp plates 108 and tightening bolt 116. The number and size of pin plates 106 may vary based on the configuration of connector pins 102 to be removed, as shown in FIG. 1. For example, the number of pin plates 106 may be based on the number of rows of connector pins 102 in connector 118 to be removed. The number of pin plates 106 may be sufficient to grasp, when used in conjunction with clamp plates 108, two opposite sides of each connector pin 102 being removed.

In some embodiments, the size of pin plates 106 may vary. The thickness of pin plates 106 may be thin enough to fit between the rows of connector pins 102, yet thick enough to grasp connector pins 102 when force is applied to the sides of pin plates 106. Pin plates 106 may have one or more alignment holes 234 allowing one or more alignment screws 114 to pass through. For example, alignment screw 114 may pass through alignment hole 234 in each pin plate 106 to hold pin plates 106 in parallel and aligned with one another.

Pin plates 106 may include vertical grooves 210 that may correspond with connector pins 102. Vertical grooves 210 may allow pin plates 106 to grip connector pins 102 during removal. As such, vertical grooves 210 may help prevent connector pins 102 from slipping out when pin plates 106 are pulled away from backplane 104. Further, vertical grooves 210 may also act to reduce the clamping force required to adequately grip connector pins 102 during removal. The dimensions of vertical grooves 210 may correspond approximately to the dimensions of connector pins 102 to be removed. For example, the dimensions of vertical grooves 210 may correspond to the long edge of a rectangular shaped connector pin 102. Further, each of vertical grooves 210 may be approximately the same dimensions or may be of different dimensions based on varying dimensions of connector pins 102. For example, some of vertical grooves 210 may be longer than other vertical grooves 210 if some of connector pins 102 are longer than other connector pins 102.

Pins plates 106 may include notch 212. Notch 212 may have dimensions to correspond to dimensions of inset 240 on attachment block 110. Notch 212 may also be configured to lock in place attachment block 110 to prevent removal of attachment block 110 from assembled removal tool 100. For example, notch 212 may include portions that partially surround or partially wrap around portions of attachment block 110. Notch 212 may further configured to provide linking of vertical movement between attachment block 110 and pin plates 106, such that when attachment block 110 moves vertically, pin plates 106 experience a corresponding movement.

In some embodiments, one clamp plate, e.g., clamp plates 108a and 108b, collectively referred to as clamp plates 108, may be placed on each side of the pin plates 106. In operation, clamp plates 108 may utilize a shim or other spacer element between clamp plates 108 and pin plates 106 based on the implementation. Clamp plates 108 may be manufactured of a hard, durable material, such as metal. In some embodiments, clamp plates 108 may have one or more holes that may be unthreaded or threaded based on the implementation. For example, claim plate 108a may have lower hole 214 and upper hole 216. Lower hole 214 may be unthreaded and upper hole 216 may be threaded. As another example, clamp plate 108b may have lower hole 224, upper hole 226, and/or alignment hole 228. Lower hole 224, upper hole 226, and alignment hole 228 may all be threaded holes.

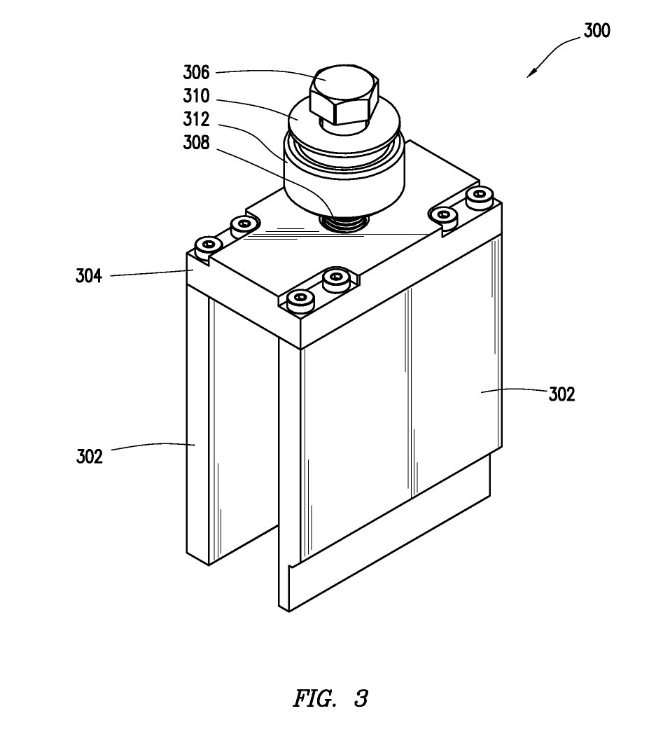

In some embodiments, attachment block 110 may sit between clamp plates 108 and restrict their movement during operation. Attachment block 110 may contain one or more holes that may that may be unthreaded or threaded based on the implementation. For example, attachment block may have upper hole 236 and alignment hole 238 that both may be threaded holes. Attachment block 110 may be configured with inset 240 that may correspond with notch 212 on pin plates 106. Inset 240 may allow pin plates 106 to lock attachment block 110 in place in removal tool 100. Attachment block 110 may allow clamp plates 108 and pin plates 106 to be loose enough so that pin plates 106 may be inserted between the rows of connector pins 102, as shown with reference to FIG. 1. Attachment block 110 also, however, may allow clamp plates 108 to be pushed apart by tightening bolt 116, and may allow pin plates 106 to be pushed together so that they clamp connector pins 102. Attachment block 110 may include interface 242 for connection to a frame assembly, which may be used for pulling removal tool 100 away from backplane 104. For example, interface 242 may be a threaded hole that may be used in conjunction with a threaded bolt to pull removal tool 100 away from backplane 104 using frame assembly 300 discussed below with reference to FIG. 3.

In some embodiments, alignment screw 114 may provide the mechanism for alignment of pin plates 106 and clamp plates 108. Alignment screw 114 may have a threaded and unthreaded portion and may be of any suitable dimension according to the implementation. Alignment screw 114 may be of any suitable material that may withstand forces exerted during operation of removal tool 100, such as, metal, aluminum, and/or any other suitable material. Lower holes 214 and 224 and alignment holes 234 may allow alignment screw 114 to hold pin plates 106 and clamp plates 108a and 108b in place over connector pins 102 being removed. For example, alignment screw 114 may be inserted through alignment bearing 204, and/or any other suitable washers or bearings, into lower hole 214. Alignment screw 114 may pass through alignment holes 234 in pin plates 106, and be screwed into lower hole 224. Such a configuration may keep pin plates 106 from becoming misaligned during operation of removal tool 100. Alignment screw 114 may allow clamp plates 108 and pin plates 106 to be loose enough so that pin plates 106 may be inserted between the rows of connector pins 102.

Fixed alignment screw 208 may provide a mechanism for alignment of attachment block 110 and clamp plate 108b. Fixed alignment screw 208 may be threaded and may be of any suitable dimension according to the implementation. Fixed alignment screw 208 may be of any suitable material that may withstand forces exerted during operation of removal tool 100, such as, metal, aluminum, and/or any other suitable material. Alignment holes 228 and 238 may allow fixed alignment screw 208 to hold clamp plate 108b and attachment block 110 fixed together and aligned during operation of removal tool 100.

Additionally, fixed tightening bolt 206 may provide a mechanism for alignment of attachment block 110 and clamp plate 108b, and may provide a stop for tightening bolt 116. Fixed tightening bolt 206 may be threaded and may be of any suitable dimension according to the implementation. Fixed tightening bolt 206 may be of any suitable material that may withstand forces exerted during operation of removal tool 100, such as, metal, aluminum, and/or any other suitable material. Upper holes 226 and 236 may allow fixed tightening bolt 206 to hold clamp plate 108b and attachment block 110 fixed together and aligned during operation of removal tool 100. Further, insertion of fixed tightening bolt 206 into upper holes 226 and 236 may provide a stop for tightening bolt 116 during operation of removal tool 100.

In some embodiments, tightening bolt 116 may provide the mechanism for tightening removal tool 100 during removal of connector pins 102. Tightening bolt 116 may be threaded and may be of any suitable dimension according to the implementation. Tightening bolt 116 may be of any suitable material that may withstand forces exerted during operation of removal tool 100, such as, metal, aluminum, and/or any other suitable material. Upper hole 216 and 226 may allow tightening bolt 116 to hold clamp plate 108a and attachment block 110 aligned during operation of removal tool 100.

When removal tool 100 is in place over connector pins 102 to be removed, pin plates 106 may be placed around connector pins 102. Then, tightening bolt 116 may be turned to press together pin plates 106. Turning tightening bolt 116 may extend tightening bolt 116 through clamp plate 108a, and the end of tightening bolt 116 may push against fixed tightening bolt 204. This force at the top of clamp plates 108 may create a tightening force at the bottom of pin plates 106. The tightening force at the bottom of pin plates 106 may compress pin plates 106 around connector pins 102. Once tightening bolt 116 has been tightened to where connector pins 102 are sufficiently grasped by pin plates 106, removal tool 100 may be pulled away from backplane 104 to remove the connector pins 102 and/or connector 118.

After clamp plates 108 and pin plates 106 firmly hold connector pins 102, an upward force may be applied to remove removal tool 100, and thus connector 118 and/or connector pins 102, from backplane 104. The upward force may be achieved in a variety of ways. One method may be to pull removal tool 100 upward by hand, which pulls connector 118 and/or connector pins 102 from backplane 104 in the process. However, removing removal tool 100 by hand may be difficult in some situations. For example, it may require more force than the operator may be capable of providing, or it may cause repetitive stress injuries if a large number of connector 118 and/or connector pins 102 require removal. Also, removing removal tool 100 by hand may be more likely to cause damage to backplane 104.

Another technique for removing connector 118 and/or connector pins 102 involves using a frame assembly to pull removal tool 100 upward. FIG. 3 illustrates an example frame assembly 300 that may be used in association with connector removal tool 100 shown in FIG. 1, in accordance with one embodiment of the present disclosure. Frame assembly 300 may include two legs 302 and cap 304. Legs 302 may be connected to cap 304 via bolts, screws, welding, and/or any other suitable connector or connection mechanism. Also, cap 304 and legs 302 may comprise a single manufactured piece. Frame assembly 300 may be used to pull removal tool 100 and the clamped connector 118 and/or connector pins 102 away from backplane 104 or other circuit board.

In some embodiments, frame assembly 300 may include one or more bolts, such as bolt 306, that may be inserted through threaded hole 308 in cap 304. One or more washers, such as washer 310, and one or more bearings, such as bearing 312, may be used in conjunction with bolt 306. Bolt 306 may be configured to thread into interface 242 in attachment block 110 of removal tool 100, shown with reference to FIG. 2. Specifically, frame assembly 300 may be positioned over removal tool 100 on backplane 104 or other circuit board. As bolt 306 is threaded into interface 242, attachment block 110 may be lifted away from backplane 104. As attachment block 110 is lifted, the rest of removal tool 100 and connector 118 and/or connector pins 102 that have been clamped may also be lifted. Bolt 306 may be turned until connector 118 and/or connector pins 102 are adequately free of the backplane 104, at which point the entire frame assembly 300 and removal tool 100 may be lifted from backplane 104. Clamp plates 108 and pin plates 106 may then be loosened, for example by loosening tightening bolt 116, in order to remove connector pins 102 from between pin plates 106. Removal tool 100 and frame assembly 300 may then be readily set up and used to remove another connector 118 and/or connector pins 102.

In some embodiments, frame assembly 300 may utilize skid plates or stand-offs to prevent damage to backplane 104 or to ensure proper fit of frame assembly 300 over removal tool 100. The skid plates or stand-offs may be made of a material similar to what is used to make frame assembly 300, or any other suitable material. The skid plates or stand-offs may be used so that the bottoms of legs 302 of frame assembly 300 do not rest directly on backplane 104. If the surface area of the bottoms of legs 302 of frame assembly 300 is small, a relatively large amount of force (the force used to pull connector pins 102 out of backplane 104) may be distributed over this small area. This force may cause damage to backplane 104 or other circuit board. In one embodiment, the skid plates or stand-offs may have a surface area resting on backplane 104 that may be much larger than the bottoms of legs 302 of frame assembly 300. Thus, the force may be distributed over a greater area of backplane 104, and may lessen any possible damage to backplane 104.

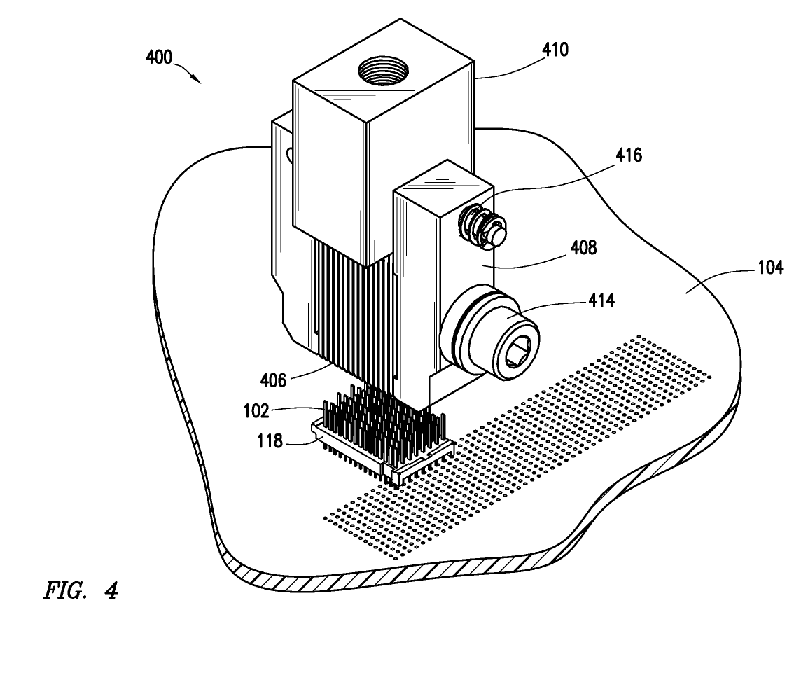

FIG. 4 illustrates another example connector removal tool 400, in accordance with one embodiment of the present disclosure. In this embodiment, removal of connector 118 and/or connector pins 102 may be accomplished by the use of removal tool 400. Although removal tool 400 is shown in association with backplane 104, removal tool 400 may also be used with any other suitable type of circuit board that uses connector pins. In operation, removal tool 400 may sit on backplane 104, and may utilize a plurality of pin plates 406 that may be pressed together to grasp connector pins 102 and/or connector 118 for removal. Clamp plates 408 may be placed around the pin plates 406. Clamp plates 408 may be used to help tighten pin plates 406 around connector pins 102. An attachment part, such as attachment block 410, may facilitate removal of removal tool 400, connector pins 102, and/or connector 118 from backplane 104. Functionally, removal tool 400 may provide an arrangement that may allow pin plates 406 to be pressed together so that they clamp connector pins 102. Alignment screw 414 may operate to hold pin plates 406 in position between clamp plates 408 and clamp pin plates 406 and clamp plates 408 onto connector pins 102 for removal. Tightening pin 416 may be used to hold together pin plates 406 and clamp plates 408.

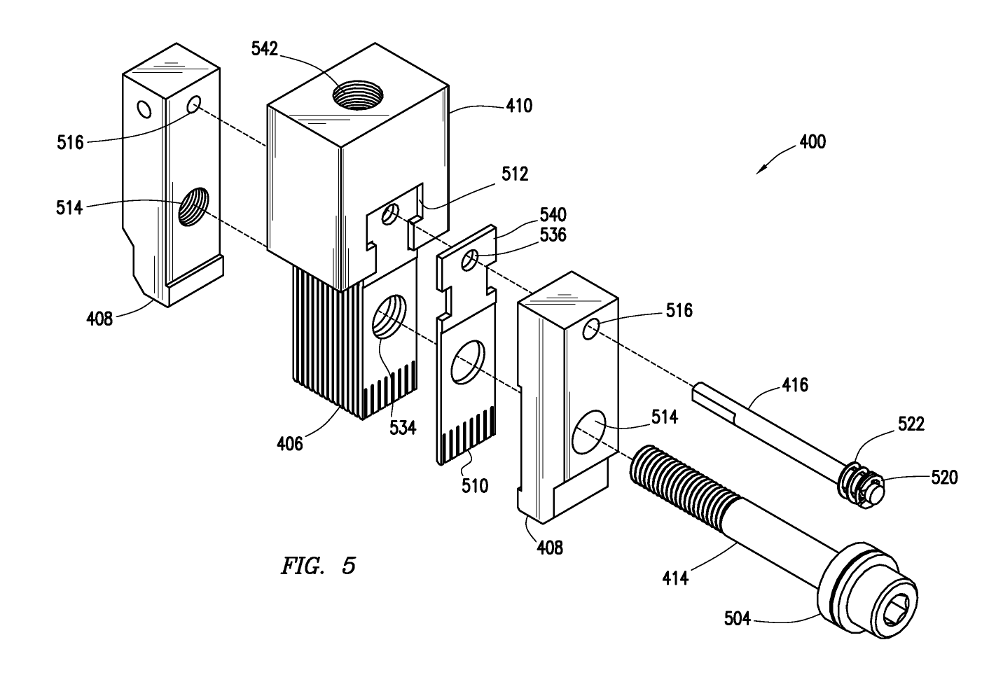

FIG. 5 illustrates an exploded view of example connector removal tool 400 shown in FIG. 4, in accordance with one embodiment of the present disclosure. In this view, the individual pieces of removal tool 400 may be seen. Removal tool 400 may include pin plates 406, clamp plates 408, attachment block 410, tightening pin 416, alignment screw 414, alignment bearing 504, and/or any other suitable components based on implementation. Connector tool 400 may be illustrated configured with particular dimensions, e.g., a particular height based on the height of the connector and/or connector pins to be removed, a particular width based on the width of the connector and/or connector pins to be removed, and a particular thickness based in part on the number of rows of pins on the connector to be removed. However, connector tool 400 may be of any dimensions suitable for a particular implementation or based on the dimensions of the connector to be removed.

Pin plates 406 may include a plurality of plates configured to grasp connector pins 102. Pin plates 406 may be manufactured from a hard material, such as metal, or any other suitable material that may withstand the clamping force applied by clamp plates 408 and alignment screw 414. The number and size of pin plates 406 may vary based on the configuration of connector pins 102 to be removed, as shown in FIG. 4. For example, the number of pin plates 406 may be based on the number of rows of connector pins 102 in connector 118 to be removed. The number of pin plates 406 may be sufficient to grasp, when used in conjunction with clamp plates 408, two opposite sides of each connector pin 102 being removed.

In some embodiments, the size of pin plates 406 may vary. The thickness of pin plates 406 may be thin enough to fit between the rows of connector pins 102, yet thick enough to grasp connector pins 102 when force is applied to the sides of pin plates 406. Pin plates 406 may have one or more alignment holes 534 allowing one or more alignment screws 414 to pass through. For example, alignment screw 414 may pass through alignment hole 534 in each pin plate 406 to hold pin plates 406 in parallel and aligned with one another.

Pin plates 406 may include vertical grooves 510 that may correspond with connector pins 102. Vertical grooves 510 may allow pin plates 406 to grip connector pins 102 during removal. As such, vertical grooves 510 may help prevent connector pins 102 from slipping out when pin plates 406 are pulled away from backplane 104. Further, vertical grooves 510 may also act to reduce the clamping force required to adequately grip connector pins 402 during removal. The dimensions of vertical grooves 510 may correspond approximately to the dimensions of connector pins 102 to be removed. For example, the dimensions of vertical grooves 510 may correspond to the long edge of a rectangular shaped connector pin 102. Further, each of vertical grooves 510 may be approximately the same dimensions or may be of different dimensions based on varying dimensions of connector pins 102. For example, some of vertical grooves 510 may be longer than other vertical grooves 510 if some of connector pins 102 are longer than other connector pins 102. Pin plates 406 may also be configured with inset 540 that may correspond with notch 512 on attachment block 410. Inset 540 may allow pin plates 406 to lock attachment block 410 in place in removal tool 400.

In some embodiments, one clamp plate 408 may be placed on each side of the pin plates 406. In operation, clamp plates 408 may utilize a shim or other spacer element between clamp plates 408 and pin plates 406 based on the implementation. Clamp plates 408 may be manufactured of a hard, durable material, such as metal. In some embodiments, clamp plates 408 may have one or more holes that may be unthreaded or threaded based on the implementation. For example, claim plates 408 may have lower hole 514 and upper hole 516. Lower hole 514 may be unthreaded or threaded and upper hole 516 may be unthreaded.

In some embodiments, attachment block 410 may sit between clamp plates 408 and restrict their movement during operation. Attachment block 410 may include notch 512. Notch 512 may have dimensions to correspond to dimensions of inset 540 on pin plates 406. Notch 512 may also be configured to lock in place attachment block 410 with pin plates 406 to prevent removal of attachment block 410 from assembled removal tool 400. For example, notch 512 may include portions that partially surround or partially wrap around portions of pin plates 406. Notch 512 may further configured to provide linking of vertical movement between attachment block 410 and pin plates 406, such that when attachment block 410 moves vertically, pin plates 406 experience a corresponding movement.

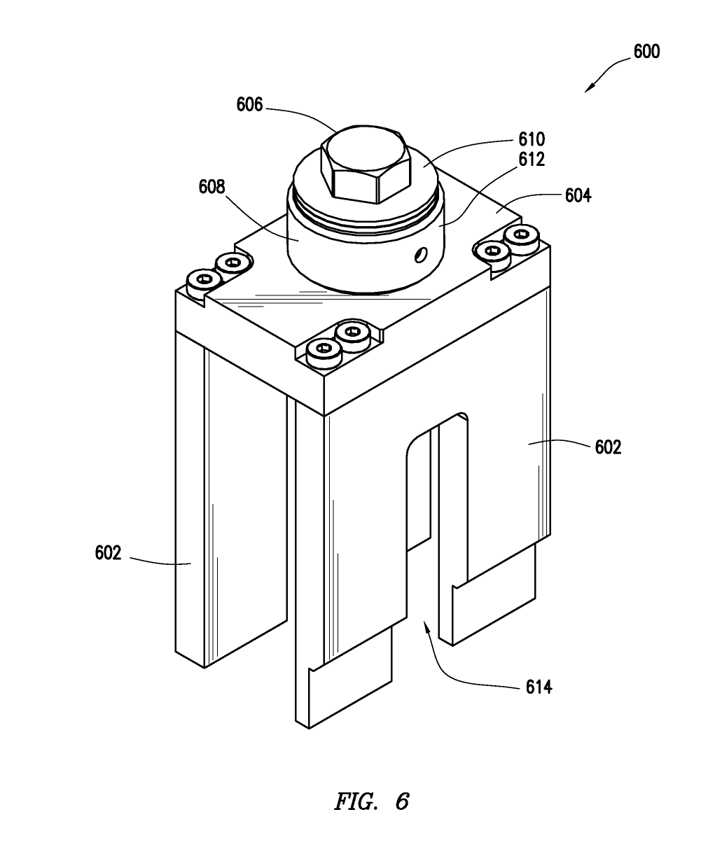

Attachment block 410 may allow clamp plates 408 and pin plates 406 to be loose enough so that pin plates 406 may be inserted between the rows of connector pins 102, as shown with reference to FIG. 4. Attachment block 410 also, however, may allow clamp plates 408 to be pushed apart by alignment screw 414, and may allow pin plates 406 to be pushed together so that they clamp connector pins 102. Attachment block 410 may include interface 542 for connection to a frame assembly, which may be used for pulling removal tool 400 away from backplane 104. For example, interface 542 may be a threaded hole that may be used in conjunction with a threaded bolt to pull removal tool 400 away from backplane 104, using a frame assembly, such as frame assembly 600 discussed below with reference to FIG. 6.

In some embodiments, alignment screw 414 may provide the mechanism for alignment of pin plates 406 and clamp plates 408 and the mechanism for tightening pin plates 406 around connector pins 102. Alignment screw 414 may have a threaded and/or unthreaded portion and may be of any suitable dimension according to the implementation. Alignment screw 414 may be of any suitable material that may withstand forces exerted during operation of removal tool 400, such as, metal, aluminum, and/or any other suitable material. Lower holes 514 and alignment holes 534 may allow alignment screw 414 to hold pin plates 406 and clamp plates 408 in place over connector pins 102 being removed. For example, alignment screw 414 may be inserted through alignment bearing 504 into lower hole 514 of a first clamp plate 408. Alignment screw may pass through alignment holes 534 in pin plates 406, and be screwed into lower hole 514 of a second clamp plate 408. Such a configuration may keep pin plates 406 from becoming misaligned during operation of removal tool 400. Alignment screw 414 may allow clamp plates 408 and pin plates 406 to be loose enough so that pin plates 406 may be inserted between the rows of connector pins 102.

In some embodiments, tightening pin 416 may provide the mechanism for alignment and/or tightening of removal tool 400 during removal of connector pins 102. Tightening pin 416 may be unthreaded and may be of any suitable dimension according to the implementation. Tightening pin 416 may be of any suitable material that may withstand forces exerted during operation of removal tool 400, such as, metal, aluminum, and/or any other suitable material. Upper hole 516 and 536 may allow tightening bolt 416 to hold clamp plates 408 and pin plates 406 aligned during operation of removal tool 400. Tightening pin 416 may include clip 520 and spring 522. Clip 520 may be configured to hold spring 522 in place on tightening pin 416. Spring 522 may provide a force that holds clamp plates 408 and pin plates 406 in place.

When removal tool 400 is in place over connector pins 102 to be removed, pin plates 406 may be placed around connector pins 102. Then, alignment bolt 414 may be turned to press together pin plates 406. Turning alignment bolt 414 may extend alignment bolt 414 through the first clamp plate 408 and the end of alignment bolt 414 may extend out of the second clamp plate 408. The force created by turning alignment bolt 414 may create a tightening force at the bottom of pin plates 406. The tightening force at the bottom of pin plates 406 may compress pin plates 406 around connector pins 102. Once alignment bolt 414 has been tightened to where connector pins 102 are sufficiently grasped by pin plates 406, removal tool 400 may be pulled away from backplane 104 to remove the connector pins 102 and/or connector 118.

After clamp plates 408 and pin plates 406 firmly hold connector pins 102, an upward force may be applied to remove removal tool 400, and thus connector 118 and/or connector pins 102, from backplane 104. The upward force may be achieved in a variety of ways. One method may be to pull removal tool 400 upward by hand, which pulls connector 118 and/or connector pins 102 from backplane 104 in the process. However, removing removal tool 400 by hand may be difficult in some situations. For example, it may require more force than the operator may be capable of providing, or it may cause repetitive stress injuries if a large number of connector 118 and/or connector pins 102 need to be removed. Also, removing removal tool 400 by hand may be more likely to cause damage to backplane 104.

Another technique for removing connector 118 and/or connector pins 102 involves using a frame assembly to pull removal tool 400 upward. FIG. 6 illustrates an example frame assembly 600 that may be used in association with connector removal tool 400 shown in FIG. 4, in accordance with one embodiment of the present disclosure. Frame assembly 600 may include two legs 602 and cap 604. Legs 602 may be connected to cap 604 via bolts, screws, welding, and/or any other suitable connector or connection mechanism. Also, cap 604 and legs 602 may comprise a single manufactured piece. Frame assembly 600 may be used to pull removal tool 400 and the clamped connector 118 and/or connector pins 102 away from backplane 104 or other circuit board.

In some embodiments, frame assembly 600 may include one or more bolts, such as bolt 606, that may be inserted through one or more threaded holes, such as threaded hole 608 in cap 604. One or more washers, such as washer 610, and one or more bearings, such as bearing 612, may be used in conjunction with bolt 606. Bolt 606 may be configured to thread into interface 542 in attachment block 410 of removal tool 400, shown with reference to FIG. 5. Specifically, frame assembly 600 may be positioned over removal tool 400 on backplane 104 or other circuit board. As bolt 606 is threaded into interface 242, attachment block 410 may be lifted away from backplane 104. As attachment block 410 is lifted, the rest of removal tool 400 and connector 118 and/or connector pins 102 that have been clamped may also be lifted. Bolt 606 may be turned until connector 118 and/or connector pins 102 are adequately free of the backplane 104, at which point the entire frame assembly 600 and removal tool 400 may be lifted from backplane 104. Clamp plates 408 and pin plates 406 may then be loosened, for example by loosening alignment screw 414, in order to remove connector pins 102 from between pin plates 406. Removal tool 400 and frame assembly 600 may then be readily set up and used to remove another connector 118 and/or connector pins 102.

In some embodiments, frame assembly 600 may utilize skid plates or stand-offs to prevent damage to backplane 104 or to ensure proper fit of frame assembly 600 over removal tool 400. The skid plates or stand-offs may be made of a material similar to what is used to make frame assembly 600, or any other suitable material. The skid plates or stand-offs may be used so that the bottoms of legs 602 of frame assembly 600 do not rest directly on backplane 104. If the surface area of the bottoms of legs 602 of frame assembly 600 is small, a relatively large amount of force (the force used to pull connector pins 102 out of backplane 104) may be distributed over this small area. This force may cause damage to backplane 104 or other circuit board. In one embodiment, the skid plates or stand-offs may have a surface area resting on backplane 104 that may be much larger than the bottoms of legs 602 of frame assembly 600. Thus, the force may be distributed over a greater area of backplane 104, and may lessen any possible damage to backplane 104.

Frame assembly 600 may also include cutouts 614 in legs 602. Cutouts 614 may allow the frame assembly 600 to sit over clamp plates 408, so that the bottoms of legs 602 sit flat on backplane 104, and/or any skid plates or stand-offs.

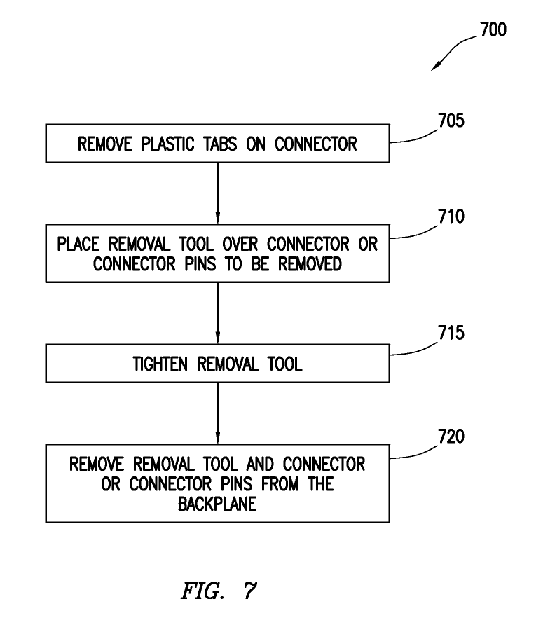

FIG. 7 illustrates an example method 700 for removal of connectors, in accordance with one embodiment of the present disclosure. Method 700 may be implemented fully or in part by a user. For illustrative purposes, method 700 is described with respect to removal tool 100 of FIG. 1 or removal tool 400 of FIG. 4; however, method 700 may be used for any other suitable removal tool configuration. Method 700 may be performed in association with a connector, such as connector 118 of FIGS. 1 and 4. Method 700 may be repeated or performed in parallel for each one of the connectors 118 illustrated in FIGS. 1 and 4 that require removal. In addition, although FIG. 7 discloses a certain order of steps to be taken with respect to method 700, the steps comprising method 700 may be completed in any suitable order.

At step 705, a user may remove the plastic tabs on the connector to be removed. For example, a user may remove plastic tabs 120 shown on connector 118 in FIG. 1. At step 710, a user may place the removal tool over the connector and/or connector pins to be removed. As example, removal tool 100 may be placed over a particular connector 118 that requires removal. Removal tool 100 may be positioned so that connector pins 102 are located between pin plates 106 and/or clamp plates 108. All connector pins 102 that are between pin plates 106 and/or clamp plates 108 will be removed once removal tool 100 is tightened and lifted from backplane 104.

At step 715, a user may tighten the removal tool. The removal tool may be tightened in a variety of ways. For example, a user may turn tightening bolt 116, shown in FIG. 1, to tighten removal tool 100. Turning tightening bolt 116 may create tension at the top of clamp plates 108 and may allow pin plates 106 to grasp connector pins 102 for removal. As another example, a user may turn alignment screw 414, shown in FIG. 4, to tighten removal tool 400. Turning alignment screw 414 may tighten pin plates 106 and clamp plates 108 to allow pin plates 106 to grasp connector pins 102 for removal.

At step 720, a user may remove the removal tool and the connector and/or connector pins from the backplane. For example, with reference to FIG. 3, frame assembly 300 may be placed over removal tool 100. Bolt 306 may be tightened to grip removal tool 100 and lift removal tool 100 and connector pins 102 away from backplane 104. As another example, with reference to FIG. 6, frame assembly 600 may be placed over removal tool 400. Bolt 606 may be tightened to grip removal tool 400 and lift removal tool 400 and connector pins 102 away from backplane 104.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A system for removing connector pins from a circuit board, comprising:
two clamp plates;
a plurality of pin plates coupled between the clamp plates, the plurality of pin plates configured to be positioned between adjacent rows of the connector pins;
an attachment block coupled between the clamp plates, the attachment block configured with an inset that corresponds with a notch on each of the plurality of pin plates for linking vertical movement of the plurality of pin plates and the attachment block; and
a tightening mechanism to tighten the clamp plates and the plurality of pin plates around the connector pins.

2. The system of claim 1, wherein the system further comprises a frame assembly configured to be positioned over the clamp plates, and configured to pull the clamp plates, the pin plates, and the connector pins off of the circuit board.

3. The system of claim 2, wherein the attachment block comprises a connector interface configured to receive a connector of the frame assembly, such that the attachment block may be pulled up from the circuit board by the frame assembly.

4. The system of claim 3, wherein the frame assembly comprises a plurality of legs coupled to a cap, wherein the one or more legs are configured to suspend the cap over the attachment block, and wherein the cap holds the connector of the frame assembly.

5. The system of claim 3, wherein the connector is a bolt, the connector interface is a threaded hole configured to receive the bolt, and wherein the bolt is configured to be inserted in the threaded hole such that an upward force on the frame assembly lifts the clamp plates and the pin plates away from the circuit board.

6. The system of claim 1, wherein the tightening mechanism includes:
a first bolt coupling a first clamp plate of the two clamp plates and the attachment block; and
a second bolt coupling a second clamp plate of the two clamp plates and the attachment block, the first bolt is configured to stop the second bolt, the second bolt is configured to provide tension between the attachment block and the second clamp plate.

7. The system of claim 1, wherein the pin plates comprise one or more grooves configured to grip the connector pins.

8. The system of claim 1, wherein the plurality of pin plates comprises a substantially parallel arrangement of plates.

9. A system for removing connector pins from a circuit board, comprising:
two clamp plates;
a plurality of pin plates coupled between the clamp plates, the plurality of pin plates configured to be positioned between adjacent rows of the connector pins;
an attachment block coupled between the clamp plates, the attachment block configured with a notch that corresponds with an inset on each of the plurality of pin plates for linking vertical movement of the plurality of pin plates and the attachment block; and
a tightening mechanism to tighten the clamp plates and the plurality of pin plates around the connector pins.

10. The system of claim 9, wherein the system further comprises a frame assembly configured to be positioned over the clamp plates, and configured to pull the clamp plates, the pin plates, and the connector pins off of the circuit board.

11. The system of claim 10, wherein the attachment block comprises a connector interface configured to receive a connector of the frame assembly, such that the attachment block may be pulled up from the circuit board by the frame assembly.

12. The system of claim 11, wherein the frame assembly comprises a plurality of legs coupled to a cap, wherein the one or more legs are configured to suspend the cap over the attachment block, and wherein the cap holds the connector of the frame assembly.

13. The system of claim 11, wherein the connector is a bolt, the connector interface is a threaded hole configured to receive the bolt, and wherein the bolt is configured to be inserted in the threaded hole such that an upward force on the frame assembly lifts the clamp plates and the pin plates away from the circuit board.

14. The system of claim 9, wherein the tightening mechanism includes a bolt coupling the two clamp plates and the plurality of pin plates.

15. The system of claim 9, wherein the pin plates comprise one or more grooves configured to grip the connector pins.

16. The system of claim 9, wherein the plurality of pin plates comprises a substantially parallel arrangement of plates.

17. A method for removing connector pins from a circuit board comprising:
placing a removal tool on the connector pins, the removal tool including:
two clamp plates;
a plurality of pin plates coupled between the clamp plates, the plurality of pin plates configured to be positioned between adjacent rows of the connector pins;
an attachment block coupled between the clamp plates, the attachment block configured with an inset that corresponds with a notch on each of the plurality of pin plates for linking vertical movement of the plurality of pin plates and the attachment block; and
a tightening mechanism to tighten the clamp plates and the plurality of pin plates around the connector pins;
tightening the removal tool;
placing a frame assembly over the removal tool; and
coupling the frame assembly and the removal tool.

18. The method of claim 17, wherein the attachment block comprises a connector interface configured to receive a connector of the frame assembly, such that the attachment block may be pulled up from the circuit board by the frame assembly.

19. The method of claim 18, wherein the connector is a bolt, the connector interface is a threaded hole configured to receive the bolt, and wherein the bolt is configured to be inserted in the threaded hole such that an upward force on the frame assembly lifts the clamp plates and the pin plates away from the circuit board.

20. The method of claim 19, wherein the tightening mechanism includes:
a first bolt coupling a first clamp plate of the two clamp plates and the attachment block; and
a second bolt coupling a second clamp plate of the two clamp plates and the attachment block, the first bolt is configured to stop the second bolt, the second bolt is configured to provide tension between the attachment block and the second clamp plate.
